(19) United States
(12) Patent Application Publication
(10) Pub. No.: US 2009/0225236 A1
(43) Pub. Date: Sep. 10, 2009

(54) High Contrast Transmissive Lcd Imager

(76) Inventor: Youngshik Yoon, Valencia, CA (US)

Correspondence Address: Thomson Licensing LLC, P.O. Box 5312, Two Independence Way, PRINCETON, NJ, 08543-5312, US

(21) Appl. No.: 11/922,957

(22) PCT Filed: Jun. 30, 2005
(86) PCT No.: PCT/US2005/023649

§ 371 Date: Dec. 27, 2007

(51) Int. Cl. H04N 5/74

(52) U.S. Cl. 348/751; 348/E05.137

(57) ABSTRACT

A projection system is described that provides improved contrast and contouring of a light signal on a pixel-by-pixel basis using a two-stage projection architecture, thus improving all video pictures. A micro-lens array is positioned between a first transmissive LCD imager and a second transmissive LCD imager in order to image on a pixel-by-pixel basis. Use of the transmissive LCD imagers minimizes the space required for the light engine, providing a high contrast low cost projector.

### FIELD OF THE INVENTION

The invention is related generally to a light projection system, and more particularly to a two-stage projection architecture.

### BACKGROUND OF THE INVENTION

Liquid crystal displays (LCDs), and particularly liquid crystal on silicon (LCOS) systems using a reflective light engine or imager, are becoming increasingly prevalent in imaging devices such as rear projection television (RPTV). In an LCOS system, projected light is polarized by a polarizing beam splitter (PBS) and directed onto a LCOS imager or light engine comprising a matrix of pixels. Throughout this specification, and consistent with the practice of the relevant art, the term pixel is used to designate a small area or dot of an image, the corresponding portion of a light transmission, and the portion of an imager producing that light transmission.

Each pixel of the imager modulates the light incident on it according to a gray-scale factor input to the imager or light engine to form a matrix of discrete modulated light signals or pixels. The matrix of modulated light signals is reflected or output from the imager and directed to a system of projection lenses which project the modulated light onto a display screen, combining the pixels of light to form a viewable image. In this system, the gray-scale variation from pixel to pixel is limited by the number of bits used to process the image signal. The contrast ratio from bright state (i.e., maximum light) to dark state (minimum light) is limited by the leakage of light in the imager.

One of the major disadvantages of existing LCOS systems is the difficulty in reducing the amount of light in the dark state, and the resulting difficulty in providing outstanding contrast ratios. This is, in part, due to the leakage of light, inherent in LCOS systems.

In addition, since the input is a fixed number of bits (e.g., 8, 10, etc.), which must describe the full scale of light, there tend to be very few bits available to describe subtle differences in darker areas of the picture. This can lead to contouring artifacts.

One approach to enhance contrast in LCOS in the dark state is to use a COLORSWITCH™ or similar device to scale the entire picture based upon the maximum value in that particular frame. This improves some pictures, but does little for pictures that contain high and low light levels. Other attempts to solve the problem have been directed to making better imagers, etc. but these are at best incremental improvements and are costly.

What is needed is a low cost projection system that enhances the contrast ratio for video images, particularly in the dark state, and reduces contouring artifacts.

### SUMMARY OF THE INVENTION

The present invention provides a projection system that provides improved contrast and contouring of a light signal on a pixel-by-pixel basis using a two-stage projection architecture, thus improving all video pictures. A micro-lens array is positioned between a first transmissive LCD imager and a second transmissive LCD imager in order to image on a pixel-by-pixel basis. Using the transmissive LCD imagers minimizes the space required for the light engine, providing a high contrast low cost projector.

### BRIEF DESCRIPTION OF THE DRAWINGS

The invention will now be described with reference to accompanying figures of which:

FIG. 1 shows a block diagram of an LCD projection system with a two-stage projection architecture according to an exemplary embodiment of the present invention; and

FIG. 2 shows an exemplary two-stage projection system according to the present invention.

### DETAILED DESCRIPTION

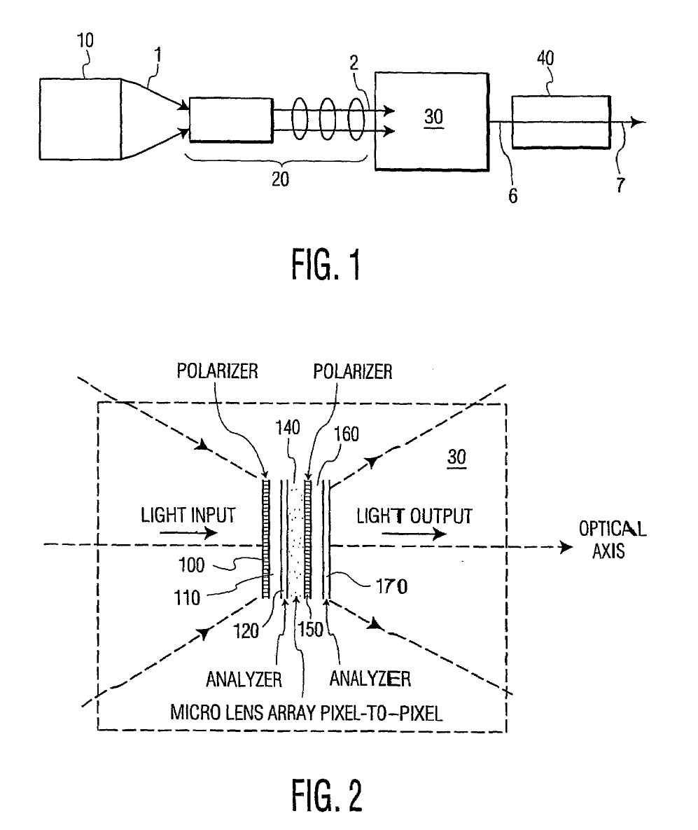

The present invention provides a low cost projection system, such as for a television display, with enhanced contrast ratio and reduced contouring. In an exemplary transmissive LCD-to-LCD projection system, illustrated in FIG. 1, white light 1 is generated by a lamp 10. Lamp 10 may be any lamp suitable for use in an LCD system. For example a short-arc mercury lamp may be used. The white light 1 enters an integrator 20, which directs a telecentric beam of white light 1 toward the projection system 30. The white light 1 is then separated into its component red, green, and blue (RGB) bands of light 2. The RGB light 2 may be separated by dichroic mirrors (not shown) and directed into separate red, green, and blue projection systems 30 for modulation. The modulated RGB light 6 is then recombined by a prism assembly (not shown) and projected by a projection lens assembly 40 onto a display screen (not shown).

Alternatively, the white light 1 may be separated into RGB bands of light 2 in the time domain, for example, by a color wheel (not shown), and thus directed one-at-a-time into a single LCD-to-LCD projection system 30.

An exemplary LCD-to-LCD projection system 30, depicted in FIG. 2, uses a two-stage projection architecture according to the present invention. The monochromatic RGB bands of light 2 are sequentially modulated by the projection system 30 on a pixel-by-pixel basis. These RGB bands of light 2 enter the projection system 30 and are polarized by a first polarizer 100. The polarizer 100 allows light of a particular polarization, such as for example, P-polarized light, to pass through the polarizer to a first transmissive LCD imager 110, while reflecting, for example, the s-polarized component at an angle, away from the projection path. The first transmissive LCD imager 110 is disposed adjacent to the first polarizer 100. The p-polarized light, which passes through the polarizer 100, is therefore incident on the first transmissive LCD imager 110. The first polarizer 100 provides light with high contrast to the first transmissive LCD imager 110.

Light output from the first transmissive LCD imager 110 is provided to a micro-lens array 140, in order to image on a pixel-to-pixel basis. After the light leaves the micro-lens array 140, it enters into a second polarizer 150. The polarizer 150 allows light of a particular polarization, such as for example, P-polarized light, to pass through the polarizer to a second transmissive LCD imager 160, while reflecting, for example, the s-polarized component at an angle, away from the projection path. The second transmissive LCD imager 160 is disposed adjacent to the second polarizer 150. The p-polarized light, which passes through the polarizer 150, is therefore incident on the second transmissive LCD imager 160. The second polarizer 150 provides light with high contrast to the second transmissive LCD imager 160.

After the light 6 leaves the second transmissive LCD imager 160, it enters the projection lens assembly 40, which projects a display image 7 onto a screen (not shown) for viewing.

Thus, a two-stage projection system using two transmissive LCD imagers each having a contrast ratio of 400:1, will provide a contrast ratio of (400)²:1, while a single-stage projection system using a much more expensive imager with a 500:1 ratio will only provide a 500:1 contrast.

First and second analyzers 120, 170 may optionally be positioned at the output of the first and second transmissive LCD imagers 110, 160, respectively. The first and second analyzers 120, 170 minimize the transmission of undesirable light from the first and second transmissive LCD imagers 110, 160, respectively.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A projection system for projecting an image comprising:
a first transmissive imager;
a second transmissive imager; and
a micro-lens array configured to image light output from the first transmissive imager on a pixel-by-pixel basis to the second transmissive imager.

2. The projection system of claim 1 further comprising a polarizer positioned adjacent to an input of each of the first and the second transmissive imagers.

3. The projection system of claim 2 further comprising an analyzer positioned adjacent to an output of each of the first and the second transmissive imagers.

4. The projection system of claim 2 wherein a first polarizer is disposed between an illumination source and the first transmissive imager.

5. The projection system of claim 1 wherein each of the first and the second transmissive imagers are Liquid Crystal Display (LCD) imagers.

6. A display, comprising:
an illumination source;
a projection system for receiving light output from the illumination system including a first transmissive imager, a second transmissive imager and a micro-lens array configured to image light output from the first transmissive imager on a pixel-by-pixel basis to the second transmissive imager; and
a screen for displaying light output from the projection system.

7. The display of claim 6 further comprising a polarizer positioned adjacent to an input of each of the first and the second transmissive imagers of the projection system.

8. The display of claim 7 further comprising an analyzer positioned adjacent to an output of each of the first and the second transmissive imagers of the projection system.

9. The display of claim 7 wherein a first polarizer is disposed between the illumination source and the first transmissive imager of the projection system.

10. The display of claim 6 wherein each of the first and the second transmissive imagers of the projection system are Liquid Crystal Display (LCD) imagers.
